(19) United States
(12) Patent Application Publication
(10) Pub. No.: US 2004/0134917 A1
(43) Pub. Date: Jul. 15, 2004

(54) Paint tray liner

(76) Inventor: Lavern Carnegie, Washington, DC (US)

Correspondence Address: BLANK ROME LLP, 600 NEW HAMPSHIRE AVENUE, N.W., WASHINGTON, DC, 20037, US

(21) Appl. No.: 10/342,285

(22) Filed: Jan. 15, 2003

(51) Int. Cl. B05C 21/00

(52) U.S. Cl. 220/570

(57) ABSTRACT

A flexible and disposable paint tray liner has a resilient band extending the entire circumference of the liner. The liner is placed over the side walls of the paint tray, so that the resilient band removably engages the side walls of the paint tray. Once the liner is engaged to the paint tray, the paint is then placed over the liner. When painting is complete, the user need only pull the liner over the top of the side walls. In another embodiment of the invention, the liner has tape with a cover strip affixed at the interior side of the liner. The liner is placed over the paint tray, so that the liner extends over the side walls of the paint tray with the tape facing the paint tray. The cover strip is then removed from the tape to expose the adhesive side of the tape. The tape is then pressed against the outer side wall of the paint tray to removably engage the side wall of the paint tray. Once painting is complete, the user can easily pull the tape apart from the paint try by sliding a finger under the liner.

### BACKGROUND OF THE INVENTION

1. Field of the Invention

The present invention relates to paint tray liners. More particularly, the present invention relates to a flexible paint tray liner which is easy to use.

2. Background of the Related Art

Various types of paint containers are used for holding, storing, and disposing of paint. When applying paint with a roller, a paint tray is used for holding the paint since it allows the user to evenly coat the roller. Paint trays are typically rectangular and shallow, with a deep well at one end and an inclined portion leading into the well. The well holds the paint and the user dips the roller into the well to apply paint to the roller. The roller is then rolled out over the inclined portion to more uniformly distribute the paint to the roller. Paint that isn't coated onto the roller travels downward along the inclined portion back into the well.

Once painting is complete, the paint tray must be cleaned to remove the unused paint. It is important that all the paint be removed from the paint tray since any remnant paint could ruin the next paint placed in the paint tray. Depending on the type of paint used, the paint tray is typically cleaned with either water or paint thinner.

However, various devices have been developed to keep the paint tray clean during use of the paint tray to facilitate or avoid the necessity to clean the paint tray. One device is a paint tray liner, such as shown, for instance, in U.S. Pat. No. 3,757,990 to Buth. Buth shows a flexible plastic liner which is placed in the paint tray. The liner is secured to the paint tray with clips, a resilient band, tape, or a drawstring.

Buth shows that, when the resilient band is used, one end of the liner is folded back to form a passageway through which the band extends. The part of the resilient band that is not in the passageway is free of the liner. The liner is placed over the paint tray so that all four ends of the liner hang over the side walls of the tray. The free end of the rubber band is then placed over the edges of the liner to retain the liner on the tray.

The resilient band of Buth, however, has several drawbacks. For instance, the resilient band of Buth is difficult to use since the user must align the free end of the band over the edges of the liner. The user must make sure that the liner hangs over the side walls completely, or paint could reach the paint tray, which must then be cleaned upon completion of painting. In addition, the user must be careful when removing the resilient band so as not to spill any paint. The user must simultaneously manage the liner and the resilient band to avoid spilling or splashing the paint left in the paint tray, and avoid tearing or ripping of the liner.

Buth also shows that, when tape is used, the liner must again be positioned so that all four ends of the liner hang over the side walls of the tray. The user then must tape the liner to the paint tray by placing the tape over the ends of the liner. The tape also has several disadvantages including, for example, that the user must ensure that there is a sufficient amount of tape to adequately retain the liner during use. The tape can be awkward to place on the liner since the user must simultaneously manage the paint tray, the liner, and the tape. In addition, the tape can be awkward to remove since it covers over the top of the liner, and can become covered with paint which inadvertently spills from the paint tray or roller.

### SUMMARY OF THE INVENTION

Accordingly, it is an object of the invention to provide a paint tray liner which is easy to use, and avoids the hassles of cleaning. It is another object of the invention to provide a paint tray liner which is inexpensive and disposable. It is yet another object of the invention to provide a paint tray liner which can be quickly and easily placed on a paint tray, and quickly and easily removed from the paint tray. It is still another object of the invention to provide a paint tray liner which can be taped to the paint tray with only one hand.

In accordance with these and other objects, the invention is a flexible and disposable paint tray liner having a resilient band extending the entire circumference of the liner. The liner has a channel, and the resilient band is positioned within the channel. The liner is placed over the side walls of the paint tray, so that the resilient band removably engages the side walls of the paint tray. Once the liner is engaged to the paint tray, the paint is then placed over the liner. When painting is complete, the user need only pull the liner over the top of the side walls and dispose of any paint left in the liner.

In another embodiment of the invention, the liner has tape with a cover strip affixed at the interior side of the liner. The liner is placed over the paint tray, so that the liner extends over the side walls of the paint tray with the tape facing the paint tray. The cover strip is then removed from the tape to expose the adhesive side of the tape. The tape is then pressed against the outer side wall of the paint tray to removably engage the side wall of the paint tray. Once painting is complete, the user can easily pull the tape apart from the paint try by sliding a finger under the liner. The liner can then be lifted from the paint tray and disposed.

These and other objects of the invention, as well as many or the intended advantages thereof, will become more readily apparent when reference is made to the following description, taken in conjunction with the accompanying drawings.

### BRIEF DESCRIPTION OF THE FIGURES

FIG. 1 shows the paint tray liner in accordance with the preferred embodiment of the invention.

FIG. 2 shows the paint tray liner having a resilient member for a fastening device in accordance with the preferred embodiment of the invention.

FIG. 3 shows the paint tray liner having an adhesive for a fastening device in accordance with an alternative embodiment of the invention.

FIG. 4 shows the paint tray liner having a closing strip.

FIG. 5 shows the paint tray liner with the closing strip sealing the liner.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

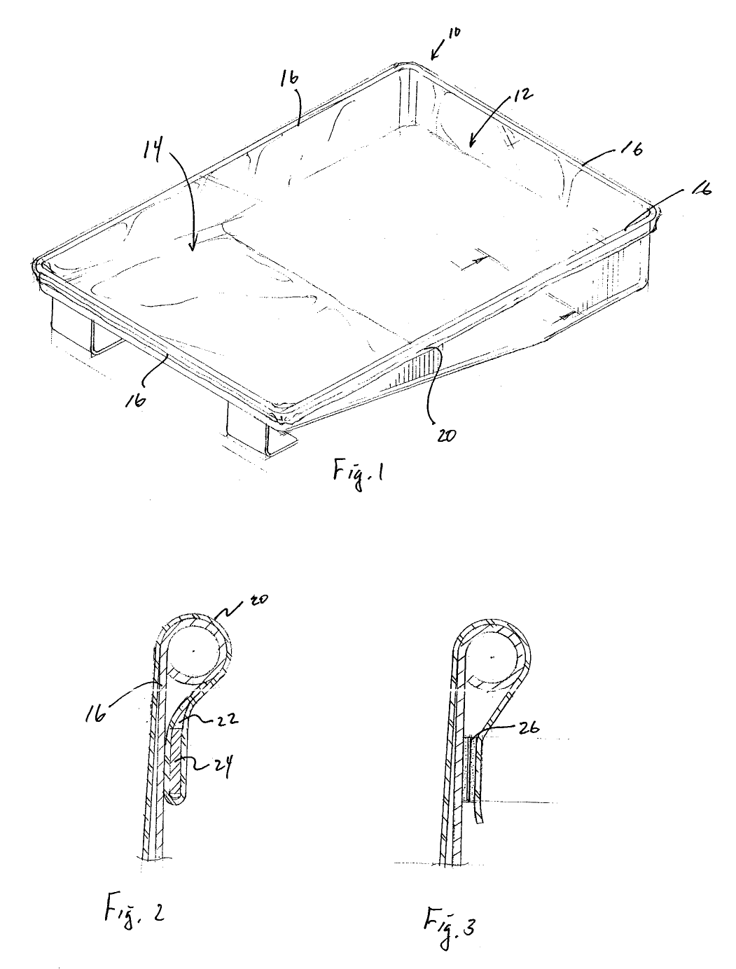

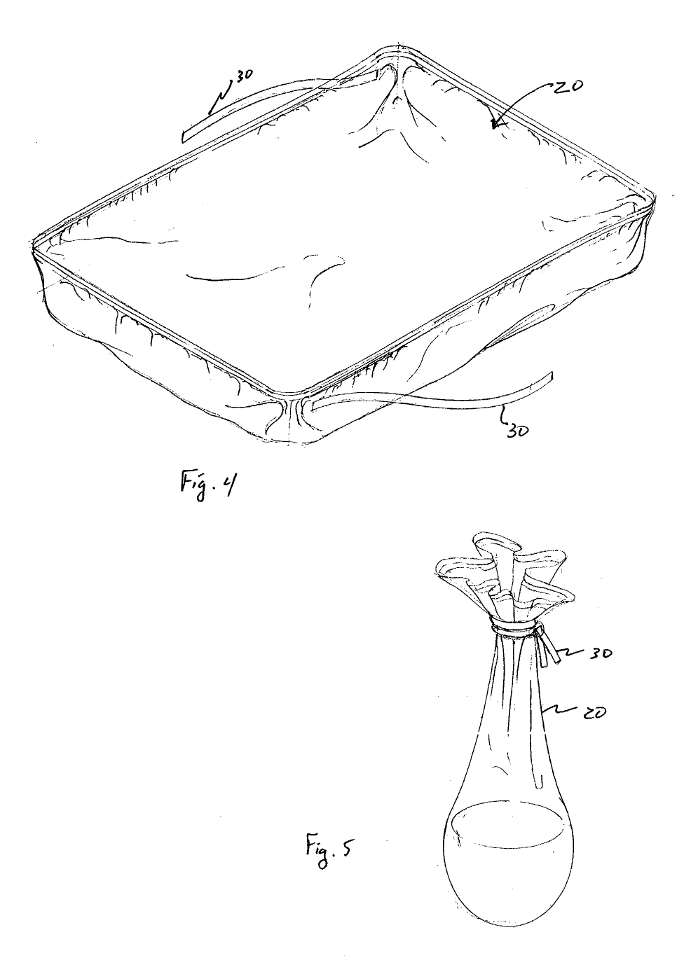

Turning to the drawings, FIG. 1 shows the liner 20 in accordance with a preferred embodiment of the invention for use with a paint tray container 10. The paint tray container 10 has a well 12, an inclined portion 14, and four side walls 16. As best shown in FIGS. 2 and 3, the side walls 16 may have an outwardly-facing lip. The liner 20 is shaped to be slightly larger than the standard paint tray 10, so that the ends of the liner 20 extend over the side walls 16 of the paint tray 10.

The liner 20 is preferably engaged to the paint tray 10 by a resilient member 24 (FIG. 2), and/or an adhesive member 26 (FIG. 3). As shown in FIG. 2, the liner 20 has a closed channel 22 which extends the entire circumference of the liner 20 and receives the resilient member 24. The resilient member 24 can be, for instance, an elongated rubber band or an elongated elastic band. Though the channel 22 is shown as being a single channel, gaps can be provided in the channel 22 at the corners, so that the liner 20 can be more easily fitted to the paint tray 10.

In addition, the resilient member 24 need not be a single member, but can be a plurality of resilient members, each respectively coupled within a closed channel to the liner body so as to cinch the liner 20. Thus, for instance, four resilient members 24 can be provided, one at each corner of the paint tray 10. It is important, however, that the resilient members 24 are not free from the liner, but instead be at least partially connected to the liner, such as being partially enclosed in the channels 22 of the liner 20, so that the resilient members 24 form a part of the liner 20 for easy placement on, and removal from, the paint tray 10 by the user.

The resilient member 24 is configured so that the liner 20 can be sufficiently easy to fit over the lip of the side walls 16. The resilient member 24 exerts sufficient force against the paint tray 10 to engage the walls 16 of the paint tray 10 so that the liner 20 does not inadvertently slip off of the paint tray 10 during use. The resilient member 24 is also configured so that it does not require excessive force or effort by the user to place the liner 20 about the paint tray 10, or to remove the liner 20 from the paint tray 10 upon completion of the painting. The resilient member 24 can also be retained by engaging the lip of the side wall 16.

FIG. 3 shows the use of an adhesive member 26, such as a tape. The adhesive member is preferably fitted to the outer side of the liner 20, along the outer edge of the liner 20. When the liner 20 is placed in the paint tray 10, the edges of the liner 20 extend over the side walls 16 so that the adhesive member 26 faces the side wall 16 of the paint tray 10.

The adhesive member 26 can be configured as a double-sided tape, with two adhesive layers, one of which is fixed to the liner 20. A cover strip is placed over the top of the other adhesive layer of the adhesive member 26. Once the liner 20 is placed in the paint tray 10, the cover strip is removed to expose the adhesive layer of the adhesive member 26. The user then presses the adhesive layer against the paint tray 10 so that it adheres to the outer portion of the side wall 16.

The adhesive member 26 need not extend the entire outer circumference of the liner 20. Rather, two or three adhesive members can be provided at each side wall 16 of the paint tray 10. Each adhesive member 26 can be provided with its own cover strip, or a single cover strip can be provided which covers all the adhesive members 26. The adhesive member 26 need not be a double-sided tape, but instead can be an adhesive layer placed directly on the liner 20. The cover strip is placed over the adhesive layer, and removed when the user is ready to press the adhesive member 26 against the paint tray 10.

As shown, the paint tray 10 and liner 20 are generally rectangular in shape. However, the liner 20 can be used with any conventional container or paint tray 20. Thus, the paint tray 10 and liner 20 need not have four walls, but can have a single circular wall, or more than four walls. The liner 20 need only be slightly larger than the container 10 so that the liner 20 can extend over the side wall(s) 16 of the container 10 and removably engage the outer side walls of the container 10.

Preferably, the entire liner 20 extends over the side walls 16 so that paint doesn't fall between the liner 20 and the paint tray 10. However, the liner 20 can be attached to the paint tray 10 at a position interior to the paint tray 10. In addition, the entire liner 20 need not extend over the side walls 16, but instead flaps can be provide on the liner 20 which are used to engage the liner 20 to the paint tray 10.

Turning to FIGS. 4 and 5, a closing strip 30 is attached to the liner 20. The closing strip 30 is preferably an elongated plastic strip having one end which is either integrally formed with the liner 20 or attached to the liner 20. The other end of the closing strip 30 is preferably secured to the liner 20, such as by an adhesive. Thus, the user can peel the closing strip 30 so that one end becomes free from the liner 20, as shown in FIG. 4, when ready to be used. The closing strip 30 can also be a thin metal twist tie, string, elastic band, or any other suitable device.

Once the liner 20 is removed from the paint tray 10, the liner 20 forms a bag which retains any unused paint. The closing strip 30 is positioned on the liner 20 so that it is at the top outer portion of the bag and can be wrapped around the liner 20 to seal the bag. As shown in FIGS. 4 and 5, more than one closing strip 30 can be provided to further facilitate sealing of the bag.

Once the liner bag 20 is lifted from the paint tray 10, the bag 20 can be sealed with the closing strip 30 and the paint stored in the bag 20. Alternatively, the bottom of the bag 20 can be pierced, and the paint drained back into the paint can for storage. Toward that end, the liner 20 can have an opening in the center of the liner 20 which is sealed with a tape. When the paint is to be drained from the liner 20, the tape is removed to reveal the opening and allow the paint to be drained.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. For instance, though the preferred embodiment of the invention is for a paint tray, the invention can be used with any reusable container. Therefore, it is not desired to limit the invention to the specific examples disclosed or the exact construction and operation shown and described. Rather, all suitable modifications and equivalents may be resorted to, falling within the scope of the invention.

We claim:

1. A liner for a container, the liner comprising an outer circumference, and a resilient member secured to the liner at substantially the entire outer circumference of the liner and extending the entire circumference of the liner, said resilient member removably engaging the liner to the container.

2. The liner of claim 1, wherein the container is a paint tray.

3. The liner of claim 1, wherein said resilient member is a rubber band.

4. The liner of claim 1, wherein said resilient member is an elastic band.

5. The liner of claim 1, further comprising a closing strip attached to said liner for sealing the liner when it is removed from the container.

6. The liner of claim 1, further comprising an opening in the liner, and a sealing tape removably sealing said opening.

7. The liner of claim 1, wherein said liner has a substantially rectangular shape.

8. The liner of claim 1, said liner further comprising at least one channel formed at substantially the entire outer circumference of the liner, and wherein said resilient member is enclosed within said at least one channel.

9. A paint tray liner for a paint tray, the paint tray liner comprising a substantially rectangular body section with ends, at least one channel formed substantially about the entire circumference of the liner at the ends of said body section, and a resilient band received in said at least one channel and extending the entire circumference of the liner, said resilient band removably engaging the liner to the container.

10. A liner for a container, the liner comprising a body section having at least one end, and an adhesive member at an outer portion of said at least one end for removably adhering the liner to the container.

11. The liner of claim 10, wherein said adhesive member comprises double-sided tape affixed to the liner.

12. The liner of claim 11, further comprising a cover strip positioned over said adhesive member.

13. The liner of claim 10, wherein said adhesive member comprises an adhesive affixed to the liner.

14. The liner of claim 12, further comprising a cover strip positioned over said adhesive.

15. The liner of claim 10, wherein the container is a paint tray.

16. The liner of claim 10, further comprising a closing strip attached to said liner for sealing the liner when it is removed from the container.

17. The liner of claim 10, further comprising an opening in the liner, and a sealing tape removably sealing said opening.

18. The liner of claim 10, wherein said liner has a substantially rectangular shape.
